(19) United States
(12) Patent Application Publication
(10) Pub. No.: US 2009/0259541 A1
(43) Pub. Date: Oct. 15, 2009

(54) Savings from retail purchases deposited/transferred to savings accounts

(76) Inventor: William T. Morrison, JR., Jacksonville, FL (US)

Correspondence Address: William T. Morrison Jr., 4917 Top Royal Lane, Jacksonville, FL, 32277, US

(21) Appl. No.: 12/384,684

(22) Filed: Apr. 8, 2009

Related U.S. Application Data
(60) Provisional application No. 61/123,902, filed on Apr. 11, 2008.

(51) Int. Cl. G06Q 30/00

(52) U.S. Cl. 705/14

(57) ABSTRACT

A system and methodology for providing customers the option of receiving their savings or discounts for the purchase of goods and services as a reduction in the purchase price of the goods and services or pay full price for their goods and services purchased and take their savings or discounts in a form that can be deposited or transferred to a deposit account, preferably savings but not limited to a savings type account, at their preferred financial institution. Most stores and businesses offer sales, discounts and coupons to attract customers to make purchases from them and most stores and businesses also report the savings or discounts to their customers at the time of purchase but the customers are only offered one choice—take the savings or discount off the purchase price of the goods or services. With the renewed interest in moving away from excessive use of credit and a renewed emphasis toward saving for the future, customers need options to help them save for such needs as retirement, college expenses for their children or grandchildren, health savings and purchase of high cost items. Financial institutions are the primary drivers of savings for the future. This system and methodology gives customers the power to make decisions about savings for the future as they carry on the daily activities of purchasing goods and services necessary to meet their every day needs.

### CROSS-REFERENCE TO RELATED APPLICATION

This application is entitled to the benefits of, and claims priority to provisional U.S. Patent Application Ser. No. 61/123,902 filed Apr. 11, 2008, and entitled “SAVINGS FROM RETAIL PURCHASES DEPOSITED/TRANSFERRED TO SAVINGS ACCOUNTS,” the entirety of which is incorporated herein by reference.

### FIELD OF THE INVENTION

The present invention relates to a system and a methodology for providing customers of retail stores the option to take any savings on goods or services purchased in the form of a discount off the purchase price of the goods and services or take the savings in the form of a deposit or transfer to their savings account at a financial institution. Savings accounts may be, but not limited to, regular savings accounts, college savings accounts, retirement savings accounts, health savings accounts, any other deposit account or may accumulate the savings for future purchases.

In its simplest form, the customer could be asked at the time of purchase if he or she wanted to pay full price for the goods or services purchased and receive a draft for the savings. This draft would function just like a check and would be fully negotiable and could be deposited into the customer's savings account. This invention does not limit the vehicle the store may use to help the customer deposit or transfer their savings to their financial institution.

In a more complex form, the store may offer their customers direct deposit of their savings to a financial institution. In the case of major retail stores, there could be a financial institution as a part of the corporate structure in which their customers' savings could be transferred into. The store may also choose to offer to serve as trustee of their customers' savings and deposit/transfer the savings into the store's bank account for the benefit of their customer.

### BACKGROUND OF THE INVENTION

There is a major concern in the world today about having enough money to support citizens in their retirement years and the younger generation is very concerned about how to pay for college. There is a lot of emphasis being exhibited in getting back to savings for future expenditures such as retirement, college education, health care and major purchases and a move away from purchasing everything on credit.

Many retail stores are now reporting the savings from purchases made in the store on the store receipt given to their customers. This is especially true of grocery stores. This trend is growing and taking on many different forms such as reward points etc. The savings generally represent the savings on goods purchased that were on sale or had a promotional discount.

Coupons are also another way customer can generate savings on goods purchased. Customer reward cards, VIP cards, and frequent shopper cards, are also used to generate discounts on goods purchased. In the present environment, these discounts are used to reduce the purchase price of the goods purchased. The customers are not given any options as to how they wish to receive their savings or discounts

This trend of offering discounts is also a major function in the services related industry where coupons are often used to pass discounts to customers.

### SUMMARY OF THE INVENTION

It is believed that there is benefit in offering customers the option of taking savings from store purchases as a discount off the purchase price of the goods or services purchased or the option of paying full price for the goods or services and taking the discounts in a draft, check or direct deposit that can be deposited or transferred to the customer's bank savings account.

This invention is a methodology and system to give customers an option of receiving savings in the form of a discount off the purchase price or taking the savings in the form of a draft or some other instrument that the customer can deposit to their savings account at their financial institution.

This invention is a methodology and system to convert coupons and sales discounts into savings that can be deposited or transferred into the customers' savings accounts at financial institutions.

This invention is a methodology and system that once the customer's savings from a purchase of goods or services is converted into a draft or some other comparable instrument, the customer can deposit the savings into retirement accounts, college savings accounts, health savings accounts, regular savings or any other similar deposit account at a financial institution.

This invention is a methodology and system that once the customer's savings from purchase of goods or services is converted into a draft or some other comparable instrument, the customer can accumulate the drafts or checks or other comparable instrument to use for future purchases of other goods and services.

### BRIEF DESCRIPTION OF THE DRAWING

The present invention will become more fully understood from the detailed description and the accompanying drawing.

FIG. 1 is a schematic block diagram representatively illustrating the sequence of steps in making a purchase of goods or services that result in a discount or savings to the customer off the original price of the goods or services purchased. It further illustrates how this discount or savings can be converted into a form that can be either deposited or transferred to the customer's account at a financial institution of his or her choice. This diagram specifically refers to drafts as the instrument used to convert the discount or savings. However, it should be understood that any number of instruments, such as checks, direct deposit, store originated transfers and other types of funds transfers, could be used to move the discount or savings to the customer's financial institution.

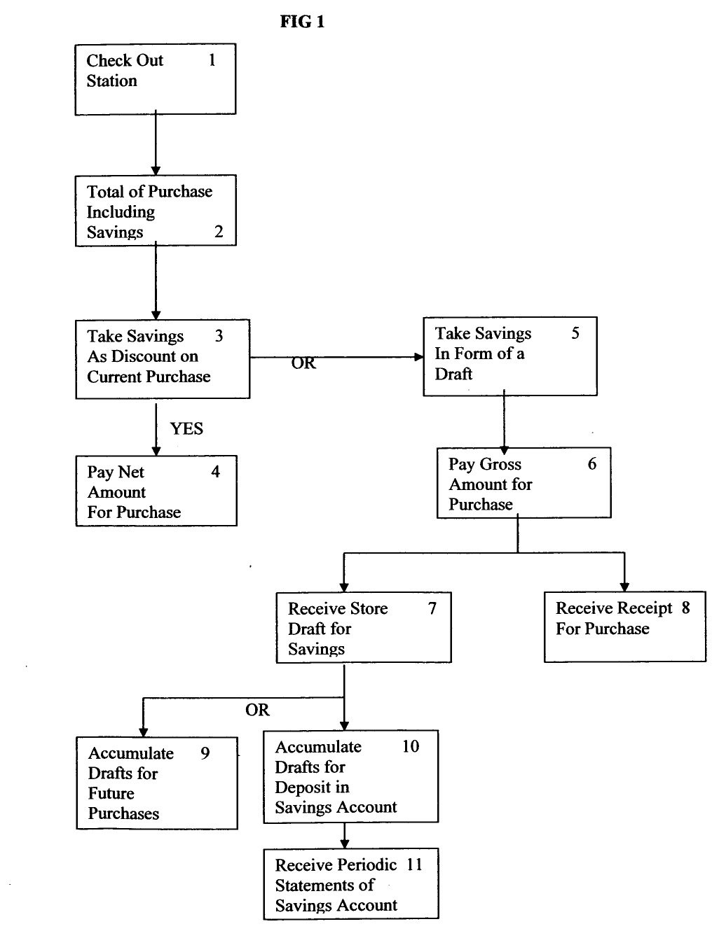

### DESCRIPTION OF EMBODIMENTS

The following description of the embodiment(s) of the present invention is merely exemplary in nature and is in no way intended to limit the invention, its application or uses. While the accompanying drawing and the following description thereof disclose the present invention in relation to embodiments thereof particularly adapted for use in purchasing goods and services at a savings or discount and the instrument used to deposit or transfer the savings to financial institution, the system and methodology of the present invention is neither intended to be interpreted nor understood to be limited to applications or embodiments utilizing these limited forms of transactions.

The present invention has a broad potential application and utility, which is contemplated to be adaptable to wide range of stores and businesses and other forms of transaction in which customers are given the opportunity to save money when purchasing goods and services via special offers, product coupons, in store promotions, special sales, joining rewards programs and any other forms of encouraging sales by offering discounts or savings. This present invention has a broad potential application as to the types of instruments used to deposit or transfer this savings into the customer's account at a financial institution. Some of these instruments may be but are not limited to negotiable drafts, checks, money orders and direct deposit or funds transfers.

Referring now to the accompanying drawing, (box 1) represents the store or business cashier or sales clerk workstation where the cost of the goods or services purchased are tallied.

In the embodiment represented by (box 2) the cost of the goods or services purchased is determined usually by the use of scanners, cash registers, computers or any other device that can determine the cost of the goods or services being purchased. In this embodiment the appropriate savings or discount would also be determined along with the total cost of the purchases. In the embodiment represented by (box 3) the customer would be given the option of taking the discount or savings calculated in (box 2) as a discount against the purchase price of the goods or services purchased or take the discount or savings in a draft or other instrument that can be deposited or transferred to their savings account.

The customer represented in (box 4) has selected the option to take the discount or savings as a reduction to the gross purchase price of the goods or services purchased. This represents the customary method used in the current environment absent this invention.

The customer chooses to take the savings or discount in the form of a draft or some other deposit type of instrument is represented by (box 5).

Since the customer chose to take the savings or discount in the form of a draft, he or she must pay the gross purchase price of the goods and services (box 6) in order to be eligible for the draft. Draft also refers to any other instrument that can be deposited or transferred to the customer's savings account at a financial institution.

In the embodiment represented by (box 7) the customer would be given a draft or some other instrument that can be used to deposit or transfer the savings or discount to their savings account at a financial institution. These deposits or transfers are not limited to a savings account but can be deposited or negotiated according to the customer's desire.

In order to complete the transaction, the customer is generally given a receipt for the goods or services purchased represented by (box 8). This receipt may reflect the savings or discount that was converted to a draft in (box 7).

If the customer chooses draft for their savings or discounts, (box 9) represents a customer who might well choose to save the drafts and use for future purchases rather than deposit them into their financial institution. This option assumes the store issues a draft, check or money order that is fully negotiable.

In the embodiment represented by (box 10) the customer deposits their draft or drafts into a savings account at their financial institution. It is assumed but not mandatory that customers will accumulate their drafts, checks or money orders until a convenient time to make their deposit. It should be clear to anyone skilled in the trade of direct deposits and the various types of funds transfers, these would not be handled by the customers and would not necessarily be accumulated before being deposited or transferred to the customer's savings account.

In the embodiment represented by (box 11) customers who deposit their savings or discounts into a savings account at their financial institution will normally receive a periodic statement or report of the balances in their accounts. These statements also serve as a gauge of the effectiveness of their dedication to savings for the future.

What is claimed is:

1. A methodology for converting savings and discounts on the purchase of goods and services into draft, check, money order, direct deposit or other instrument that can be deposited or transferred into customers' savings accounts at their financial institution comprising the steps of:
(a) store or business advertises products or services for sale and the savings is calculated at the time of the purchase of the items on sale;
(b) manufacturers, stores or businesses offer coupons for certain goods and services to be used at the time of purchase to reduce the cost of the items covered by the coupons;
(c) stores and businesses offer discounts on goods and services to customers who have joined the store or business rewards program and the savings and discounts are calculated at the time of purchase;
(d) stores and businesses offer discounts on goods and services to customers who have been identified by the store or business as VIP (very important person) customers and the savings and discounts are calculated at the time of purchase;
(e) stores and businesses offer discounts on goods and services to customers who have been identified by the store or business as frequent shoppers and the savings and discounts are calculated at the time of purchase;
(f) reporting or otherwise calculating the discounts and savings on goods or services purchased by the customers at the time of checkout or at the time of paying for their purchases; and
(g) giving the customers the option of taking their savings or discounts as a reduction to the purchase price of the goods or services purchased or receiving their savings or discount in an instrument that can be deposited or transferred to a deposit account at their selected financial institution.

2. A methodology and system according to claim 1, to allow a customer of a store or business to receive their savings or discount on goods or services purchased in the form of a store or business negotiable draft that can be deposited into a deposit account, preferably savings but not limited to savings type accounts, at a financial institution of their choice.

3. A methodology and system according to claim 1, to allow a customer of a store or business to receive their savings or discount on goods or services purchased in the form of a negotiable check that can be deposited into a deposit account, preferably savings but not limited to savings type accounts, at a financial institution of their choice.

4. A methodology and system according to claim 1, to allow a customer of a store or business to receive their savings or discount on goods or services purchased in the form of a negotiable money order that can be deposited into a deposit account, preferably savings but not limited to savings type accounts, at a financial institution of their choice.

5. A methodology and system according to claim 1, to allow customers of a store or business to receive their savings or discount on goods or services purchased in the form of a electronic direct deposit into a deposit account, preferably savings but not limited to savings type accounts, at a financial institution of their choice.

6. A methodology and system according to claim 1, to allow customers of a store or business to receive their savings or discount on goods or services purchased in the form of a funds transfer into a deposit account, preferably savings but not limited to savings type accounts, at a financial institution of their choice.

7. A methodology and system according to claim 1, to allow customers of a store or business to receive their savings or discount on goods or services purchased in any instrument that currently exist or that may evolve in the future for the purpose of transferring funds from one entity/person to another.

8. A methodology and system according to claim 1, to allow customers of a store or business to receive their savings or discount on goods or services purchased in the form of a store issued draft, check or money order to accumulate said drafts, checks or money orders to be used to pay for future purchases at the store or business that issued the instruments or any other store or business that is willing to negotiate the drafts, checks or money orders.
